(19) United States
(12) Patent Application Publication
(10) Pub. No.: US 2014/0091951 A1
(43) Pub. Date: Apr. 3, 2014

(54) NIGHT SAFETY WARNING APPARATUS AND METHOD HAVING ILLUMINATED INFLATABLE COLUMN

(71) Applicant: CODE 3, INC., St. Louis, MO (US)

(72) Inventors: Roger L. Miller, Crestwood, KY (US); Joseph Bakalor, Maryland Heights, MO (US)

(73) Assignee: CODE 3, INC., St. Louis, MO (US)

(21) Appl. No.: 13/828,796

(22) Filed: Mar. 14, 2013

Related U.S. Application Data
(60) Provisional application No. 61/708,284, filed on Oct. 1, 2012.

(51) Int. Cl. F21V 33/00; G08G 1/0955

(52) U.S. Cl. CPC F21V 33/0088; G08G 1/0955
USPC 340/908; 362/96

(57) ABSTRACT

An illuminated, inflatable mast assembly positioned at a site and deployed for warning on-coming drivers of vehicles of the location of the site.

### BACKGROUND

The present invention generally relates to apparatus used at twilight or at night for warning drivers of a location, such as a construction site.

### SUMMARY

In one form, the apparatus of the invention comprises a base and an inflatable mast attached to and supported by the base. The mast comprises a flexible, material having at least one area which is translucent or transparent. A light source supported by the base is positioned within the mast to illuminate the mast when the light source is energized. A blower in communication with the mast selectively inflates the mast.

In another form, the invention is a method of providing a night safety warning comprising the steps of:
Providing an inflatable mast assembly comprising a flexible material, the mast attached to and supported by a base and having a light source supported by the base and positioned within the mast;
Positioning the mast assembly at a location (e.g., a construction site) to warn observers of the location; and
Inflating the mast and energizing the light source.

Other objects and features will be in part apparent and in part pointed out hereinafter.

### BRIEF DESCRIPTION OF THE DRAWINGS

FIG. 1 is a side view with part of the base broken away and part of the mast broken away of one embodiment of an apparatus of the invention with the column inflated.

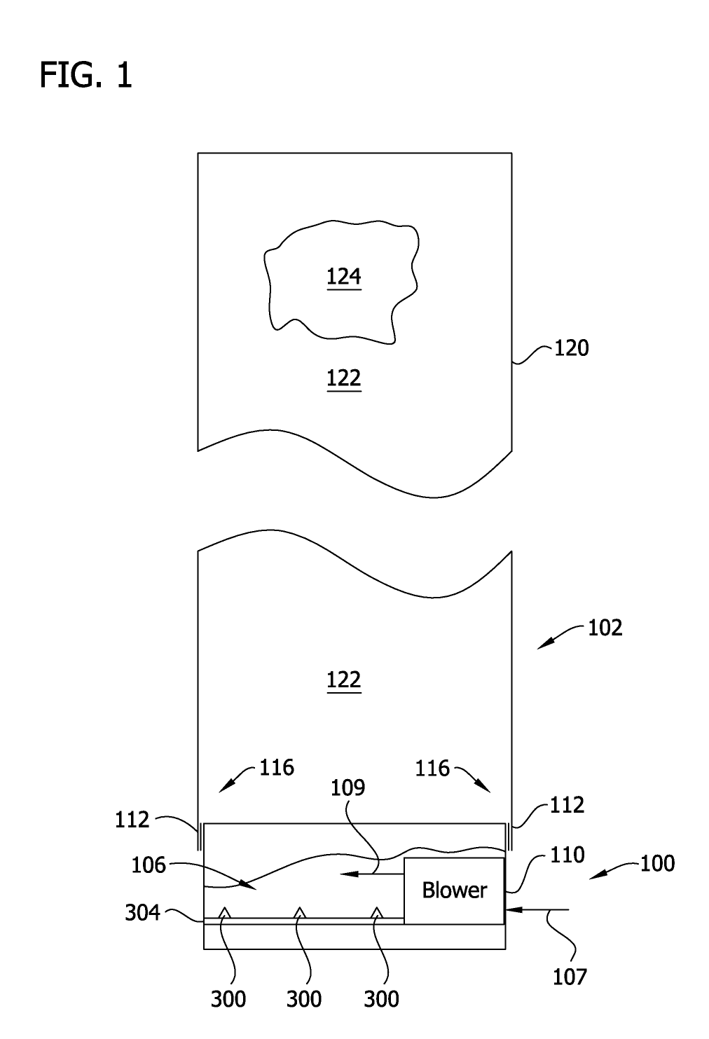

FIG. 2 is a bottom perspective view of one embodiment of a base for the apparatus of the invention.

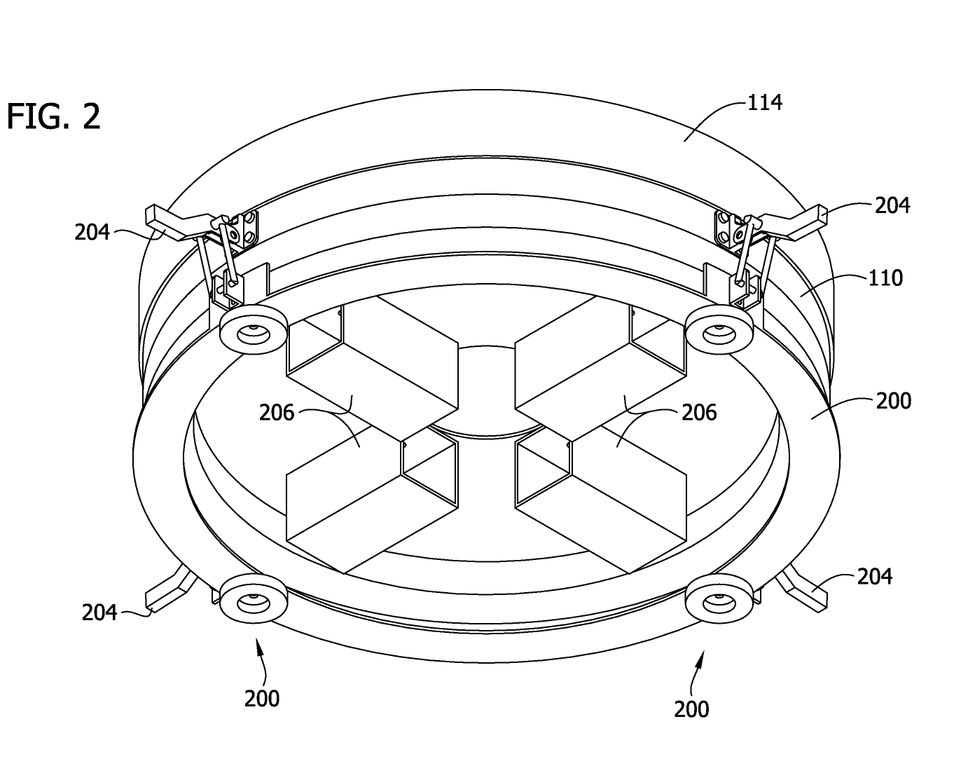

FIG. 3 is a vertical cross sectional view of the base of FIG. 2 taken through the latches.

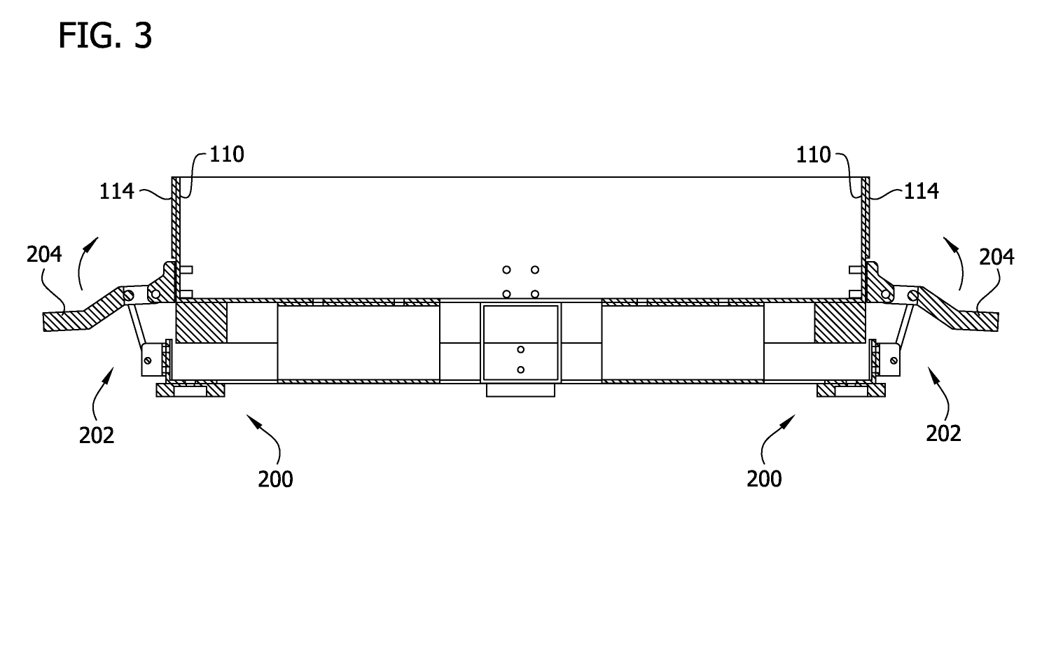

FIG. 4 is a side view of one embodiment of an apparatus of the invention mounted on a swinging platform in a trunk of a vehicle. The platform is in its lower position for storing the apparatus with its mast deflated and collapsed in the trunk.

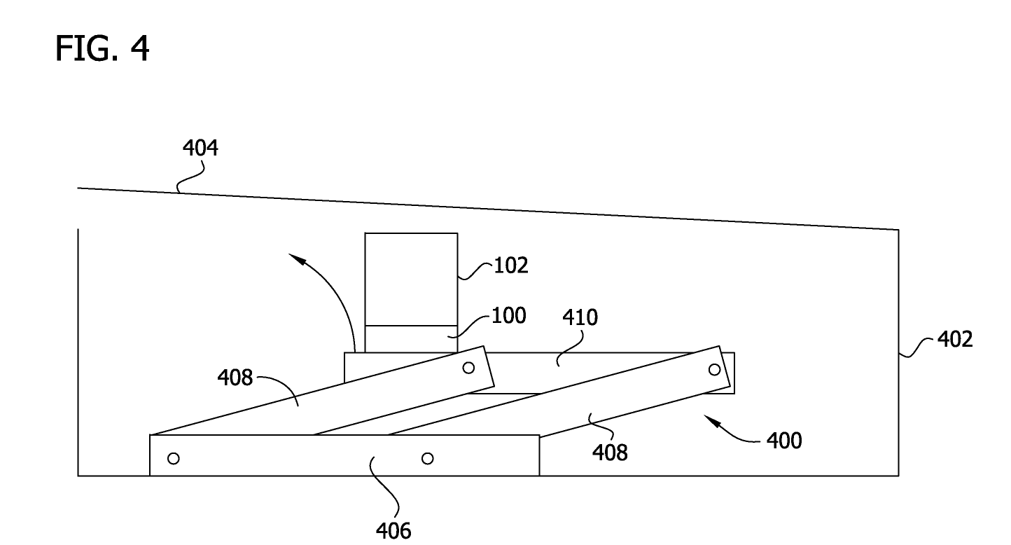

FIG. 5 is a side view of one embodiment of an apparatus of the invention mounted on a swinging platform in a trunk of a vehicle. The platform is in its upper position and the apparatus is deployed with the column inflated.

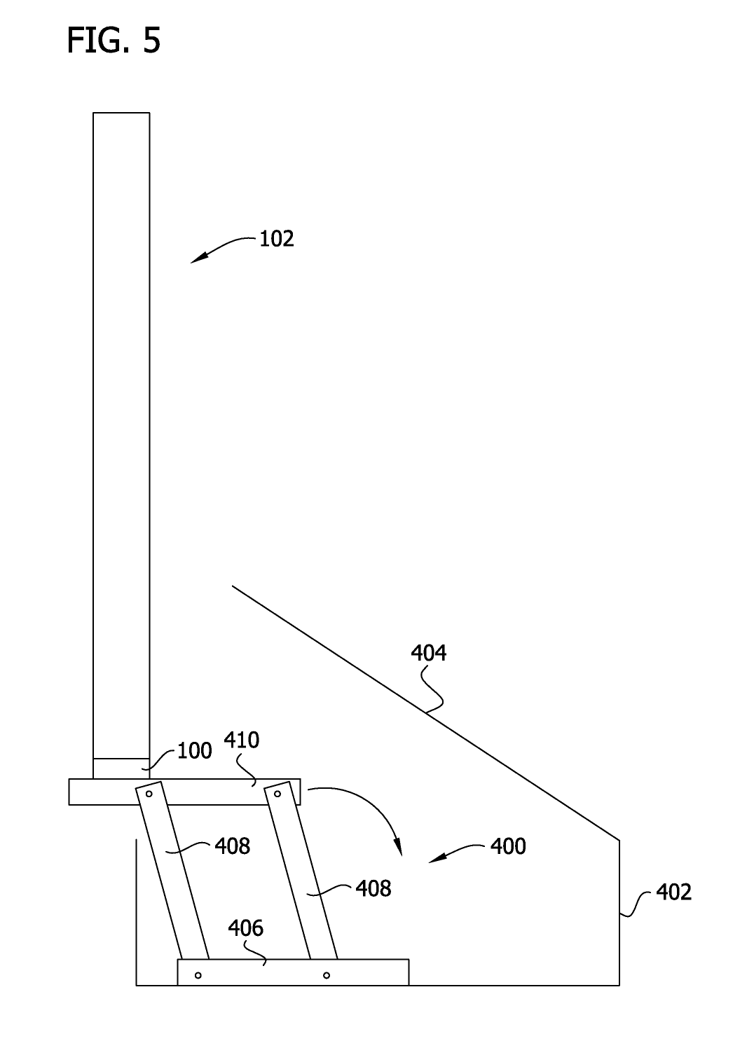

FIG. 6 is a block diagram of electronics of one embodiment of an apparatus of the invention illustrating the electronics.

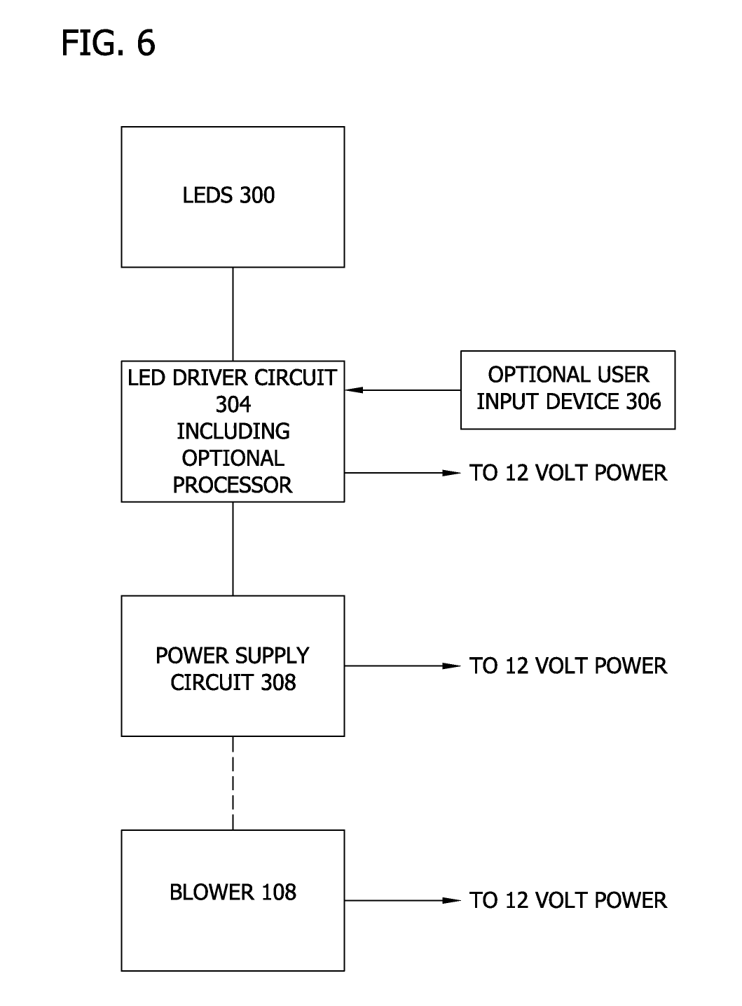

Corresponding reference characters indicate corresponding parts throughout the drawings.

### DETAILED DESCRIPTION

In one form, the apparatus of the invention comprises a base 100 and an inflatable mast 102 attached to and supported by the base. The mast 102 comprises a flexible, material having at least one area which is translucent or transparent. A light source 106 supported by the base 100 is positioned within the mast 102 to illuminate the mast 102 when the light source is energized. A blower 110 in communication with the mast 102 selectively inflates the mast 102.

The base 100 comprises one or more of the following. A cylindrical section 110 with a fastener 112 along its outer perimeter engages the bottom of the mast 102 and seals it to the cylindrical section 110. The light source 106 and blower 110 are positioned within the cylindrical section and within the mast 102. For example, the fastener 112 may be a hook fabric 114, such as Velcro® hooks, attached to the exterior perimeter of the cylindrical section and a loop fabric 116, such Velcro® loops, attached to the interior perimeter of the bottom of the mast 102. The base has engaging device 200 (e.g., an engaging means such as magnets, padded magnets and/or suction cups) to attach to a surface of a vehicle, such as hood, roof or trunk of the vehicle. Alternatively, the base may be weighted to rest on a surface such as a roadway. The engaging device has a release mechanism 202 to disengage the engaging device from a surface to which it is attached. For example, latches 204 may be rotated upward to move the engaging device 200 away from a surface to which the engaging device is attached. Feet 206 on the underside of the base 100 move toward a surface to which the engaging device is attached and rest on the surface and push against the surface. As the latches 204 are rotated upward, the engaging device 200 is lifted away from the surface.

In one form, the base 100 includes a frame 400 adapted to be positioned in a compartment 402 (e.g., trunk or portable container). The frame 400 swings out of the compartment to permit the mast 102 to be inflated. The frame 400 includes a weighted element 406 resting or attached to the floor of the compartment 402. Element 406 is connected via a linkage 408 to a platform 410 to which the apparatus is attached. The linkage (such as a 4-bar linkage, a parallelogram linkage, a cam mechanism) allows the platform to swing out away from the weighted element when a lid 404 of the compartment 402 is open.

The inflatable mast 102 comprises one or more of the following. In one form, the mast 102 is a flexible, plastic column material 120 (air dancers) which moves side to side and back and forth when inflated. One area 122 (front) of the mast 102 may be translucent or transparent and an opposing area 124 (rear) may be opaque (for use on a two-way roadway so the drivers approaching from the rear 124 of the column are less likely notice it as compared to drivers approaching from the front 122 of the column) In one form, the mast 102 may be a solid column without appendages about 18″ (±10%) in diameter and about 10′-12′ (±10%) in height, in one form. In another form, the mast 102 may be a solid column without appendages about 24″ (±10%) in diameter and about 20′-24′ (±10%) in height. These dimensions provide an apparatus which is highly visible to a driver approaching the apparatus.

The light source 106 comprises one or more of the following. Upward directed LEDs 300 and an LED driver circuit 302 on a board 304 located in the base 100 illuminate the mast 102. The LEDs 300 may be 2 or more different colors. The upward directed LEDs 300 direct light within the column 120 to illuminate the column. The colors may flash alternatively or in an overlapping pattern during which only one color is illuminated during one period of time of the overlapping pattern and during which two or colors are illuminated during a second period of time of the overlapping pattern. Some red LEDs and some blue LEDs may be used. Variable color LEDs with color output varied and controlled by a processor controlling an LED driver circuit may be used. The LEDs may be amber LEDs for certain sites such as utility sites. The LEDs are in a circle along a perimeter of the base and the column.

An LED driver circuit 302 selectively energizes the LEDs. The driver circuit may include a processor. A 12 v driver circuit may be adapted to be connected to a vehicle battery. The driver circuit may include a processor programmable with flashing patterns, for varying intensity, for random flashing and/or colors. An optional user input device 306 (keypad, button, switch) controls the processor and/or the light patterns. A 12 v power supply 308 is optionally adapted to be connected to a vehicle battery. Alternatively, an optional power supply circuit 308 (which may be part of the driver circuit) provides power to the driver circuit and the blower 110. Alternatively, an optional power supply circuit connects to a power source such as a vehicle battery. Alternatively, an optional power supply circuit supplies power to the blower. Alternatively, an optional power supply circuit may be part of the blower.

The blower 110 comprises one or more of the following. A motor and a fan driven by the motor have an intake port 107 communicating with air external to the mast 102 and base and an output port 109 communicating with the interior of the mast 102 for forcing air into the mast 102 to inflate the mast 102 when the motor is energized. A 12 v blower connects to a vehicle battery and/or the power supply circuit 308.

In another form, the invention is a method of providing a night safety warning at a roadway location comprising the steps of:
Providing an inflatable mast 102 assembly comprising a flexible material, the mast 102 attached to and supported by a base 100 and having a light source 300 supported by the base 100 and positioned within the mast 102 to illuminate the mast when the light source is energized;
Positioning the mast 102 assembly at the roadway (e.g., a construction site) to warn observers approaching in a vehicle of the location; and
Inflating the mast 102 and energizing the light source 300 causing the illuminated mast to move about increasing visibility of the inflated mast 102 to on-coming drivers approaching the inflated mast and providing a warning signal to on-coming drivers approaching the inflated mast.

The method may include positioning, inflating and energizing the mast 102 assembly at night at a construction site to warn on-coming drivers of vehicles of the location of the construction site.

The inflatable mast 102 in one form does not have any horizontal appendages such as arms extending from the mast 102. For example, the mast 102 may be in a form similar to the light tower of U.S. Pat. No. 7,621,650 and inflatable structure of U.S. Pat. No. 6,322,230, the entire disclosures of which are incorporated herein by reference. The inflatable mast 102 in one form does not have any illumination other than the LEDs in the base so that the LEDs in the base are the only light source of the apparatus.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the invention may include different processor-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus comprising:
A base;
An inflatable mast attached to and supported by the base, the mast comprising a flexible, and material having at least one area which is translucent or transparent;
A light source supported by and positioned within the base and positioned within the mast to illuminate the mast when the light source is energized; and
A blower in communication with the mast to selectively inflate the mast.

2. The apparatus of claim 1 wherein the base comprises a cylindrical section with a fastener for engaging the mast and having the light source and the blower positioned within the cylindrical section; and wherein the base further comprises at least one of the following:
Wherein the base has an engaging device to attach to a vehicle surface including at least one of a hood, a roof or a trunk of the vehicle; and
Wherein the base has engaging device and a release mechanism to release the engaging device from a surface to which it is attached.

3. The apparatus of claim 1 wherein the base comprises at least one of the following:
A frame adapted to be positioned in a trunk of a vehicle which swings out of the trunk to deploy and inflate the mast; and
A frame including a weighted element connected via a linkage to a platform to which the apparatus is attached wherein the linkage allows the platform to swing out away from the weighted element; and
A frame including a weighted element connected via a linkage to a platform to which the apparatus is attached wherein the linkage includes at least one of a 4-bar linkage, a parallelogram linkage, and a cam mechanism to allow the platform to swing out away from the weighted element.

4. The apparatus of claim 1 wherein the inflatable mast comprises a flexible, plastic column material which moves when inflated having one area that is translucent and having an opposing area that is opaque for use on a two-way roadway so the drivers approaching from the opposing area of the column are less likely to notice the mast.

5. The apparatus of claim 4 wherein the inflatable mast comprises at least one of the following:
a flexible, plastic column without any appendages material about 18″ in diameter and about 10′-12′ in height; and
a flexible, plastic column without any appendages material about 24″ in diameter and about 20′-24′ in height.

6. The apparatus of claim 1 wherein the light source comprises at least one of the following:
Upward directed LEDs and an LED driver circuit on a board located in the base;
Upward directed LEDs having two (2) or more different colors and an LED driver circuit on a board located in the base;
Upward directed colored LEDs and an LED driver circuit on a board located in the base for flashing the LEDs with color varied and controlled by a processor controlling an LED driver circuit;
Upward directed, variable color LEDs with color varied and controlled by a processor controlling an LED driver circuit wherein some of the LEDs are energized alternatively with other LEDS or wherein some of the LEDs are energized and overlap with other LEDS are energized;
Upward directed LEDs along a diameter of a circle within the base and within the column; and
Upward directed amber LEDs and an LED driver circuit on a board located in the base.

7. The apparatus of claim 1 wherein the light source comprises at least one of the following:
A driver circuit including a processor to energize the light source in different light patterns;
A 12 v driver circuit adapted to be connected to a vehicle battery;
A driver circuit including a processor programmable with flashing patterns, for varying intensity or random flashing and/or colors of the light source; and
A user input apparatus to control a processor to energize the light source in different light patterns.

8. The apparatus of claim 1 wherein the blower comprises a 12 v motor for connecting to a vehicle battery and a fan driven by the motor having a intake port communicating with air external to the mast and an output port communicating with the interior of the mast for inflating the mast when the motor is energized.

9. A method of providing a night safety warning at a roadway location comprising the steps of:
Providing an inflatable mast assembly comprising a flexible material, the mast attached to and supported by a base and having a light source supported by the base and positioned within the mast to illuminate the mast when the light source is energized;
Positioning the mast assembly at the roadway to warn observers approaching in a vehicle of the location; and
Inflating the mast and energizing the light source causing the illuminated mast to move about increasing visibility of the inflated mast to on-coming drivers approaching the inflated mast and providing a warning signal to on-coming drivers approaching the inflated mast.

10. The method of claim 9 wherein the positioning, inflating and energizing the mast assembly occurs at night at a construction site to warn on-coming drivers of vehicles of the location of the construction site.

11. The method of claim 9 wherein the base comprises a cylindrical section with a fastener for engaging the mast and having the light source and blower positioned within the cylindrical section; and wherein the base further comprises at least one of the following:
Wherein the base has an engaging device to attach to a vehicle surface including at least one of a hood, a roof or a trunk of the vehicle; and
Wherein the base has engaging device and a release mechanism to release the engaging device from a surface to which it is attached.

12. The method of claim 9 wherein the base comprises at least one of the following:
A frame adapted to be positioned in a trunk of a vehicle which swings out of the trunk to deploy and inflate the mast; and
A frame including a weighted element connected via a linkage to a platform to which the apparatus is attached wherein the linkage allows the platform to swing out away from the weighted element; and
A frame including a weighted element connected via a linkage to a platform to which the apparatus is attached wherein the linkage includes at least one of a 4-bar linkage, a parallelogram linkage, and a cam mechanism to allow the platform to swing out away from the weighted element.

13. The method of claim 9 wherein the inflatable mast comprises a flexible, plastic column material which moves when inflated having one area that is translucent and having an opposing area that is opaque for use on a two-way roadway so the drivers approaching from the opposing area of the column are less likely to notice the mast.

14. The method of claim 13 wherein the inflatable mast comprises at least one of the following:
a flexible, plastic column without any appendages material about 18″ in diameter and about 10′-12′ in height; and
a flexible, plastic column without any appendages material about 24″ in diameter and about 20′-24′ in height.

15. The method of claim 9 wherein the light source comprises at least one of the following:
Upward directed LEDs and an LED driver circuit on a board located in the base;
Upward directed LEDs having two (2) or more different colors and an LED driver circuit on a board located in the base;
Upward directed colored LEDs and an LED driver circuit on a board located in the base for flashing the light source;
Upward directed, variable color LEDs with color varied and controlled by a processor controlling an LED driver circuit;
Upward directed, variable color LEDs with color varied and controlled by a processor controlling an LED driver circuit wherein some of the LEDs are energized alternatively with other LEDS or wherein some of the LEDs are energized and overlap with other LEDS are energized;
Upward directed LEDs along a diameter of a circle within the base and within the column; and
Upward directed amber LEDs and an LED driver circuit on a board located in the base.

16. The method of claim 9 wherein the light source comprises at least one of the following:
A driver circuit including a processor to energize the light source in different light patterns;
A 12 v driver circuit adapted to be connected to a vehicle battery;
A driver circuit including a processor programmable with flashing patterns, for varying intensity or random flashing and/or colors of the light source; and
A user input apparatus to control a processor to energize the light source in different light patterns.

17. The method of claim 9 wherein inflating comprises providing a blower having a 12 v motor for connecting to a vehicle battery, having a fan driven by the motor, and having a intake port communicating with air external to the mast and an output port communicating with the interior of the mast for inflating the mast when the motor is energized.

18. An apparatus comprising:
A light source including upward directed colored LEDs and a 12 v LED driver circuit adapted to be connected to a vehicle battery on a board located in the base for flashing the LEDs with color varied and controlled by a processor controlling an LED driver circuit;
A blower;
A base comprising a cylindrical section with a fastener for engaging the mast and having the light source and a blower positioned within the cylindrical section; and wherein the base further comprises an engaging device to attached to a surface of the vehicle and a release mechanism to release the engaging device from a surface to which it is attached;
An inflatable mast attached to and supported by the base, the mast comprising a flexible, column material which moves when inflated having at least one area which is translucent or transparent and having an opposing area that is opaque for use on a two-way roadway so the drivers approaching from the opposing area of the column are less likely to notice the mast;
Wherein the light source is supported by and positioned within the base and positioned within the mast to illuminate the mast when the light source is energized; and
Wherein the blower in communication with the mast to selectively inflate the mast.

19. The apparatus of claim 18 wherein the base comprises at least one of the following:
A frame adapted to be positioned in a trunk of a vehicle which swings out of the trunk to deploy and inflate the mast; and
A frame including a weighted element connected via a linkage to a platform to which the apparatus is attached wherein the linkage allows the platform to swing out away from the weighted element; and
A frame including a weighted element connected via a linkage to a platform to which the apparatus is attached wherein the linkage includes at least one of a 4-bar linkage, a parallelogram linkage, and a cam mechanism to allow the platform to swing out away from the weighted element.
